(19) United States
(12) Patent Application Publication
(10) Pub. No.: US 2007/0253365 A1
(43) Pub. Date: Nov. 1, 2007

(54) SERVICE-AWARE QUALITY MONITORING AND CONTROL IN A RADIO ACCESS NETWORK

(76) Inventors: Tomas Hedberg, Stockholm (SE); Paul Stjernholm, Lidingo (SE)

Correspondence Address: ERICSSON INC., 6300 LEGACY DRIVE, M/S EVR 1-C-11, PLANO, TX, 75024, US

(21) Appl. No.: 11/534,393

(22) Filed: Sep. 22, 2006

Related U.S. Application Data
(60) Provisional application No. 60/745,774, filed on Apr. 27, 2006.

(51) Int. Cl. H04Q 7/00

(52) U.S. Cl. 370/329

(57) ABSTRACT

A system and method for monitoring performance of an identified end-user service in a radio access network (RAN) in which multiple services utilize the same bearer service. A core network node such as an SGSN includes an operator-configurable mapping table for mapping end-user services to Service Identifiers. The SGSN sends a Service Identifier to the RAN, preferably at bearer establishment or modification. Service event counters in the RAN are configured to measure performance parameters for the identified end-user service. The Service Identifier may be sent as a tag in a radio bearer request or modify message, and the RAN may be configured to apply different parameter settings for network counters depending on the service identifier tag received in the radio bearer request message.

### CROSS-REFERENCE TO RELATED APPLICATIONS

This application claims benefit of U.S. Provisional Application No. 60/745,774 filed Apr. 27, 2006, the disclosure of which is incorporated herein by reference.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

This invention relates to radio telecommunication systems. More particularly, and not by way of limitation, the invention is directed to a system and method for monitoring the performance of a particular service in a radio access network.

Mobile radio network operators need to be able to observe the performance of the Radio Access Network (RAN) during operational conditions. This capability is partly provided though statistical counters, for example, in the Radio Network Controller (RNC) and the Radio Base Station (RBS), normally down to the cell level.

The 3GPP specifications state that the UMTS Terrestrial Radio Access Network (UTRAN) and the GSM, GPRS, EDGE Radio Access Network (GERAN) radio access networks are to be “service agnostic”, that is, they are not aware of the particular end-user service transported over the bearer service in the RAN, i.e., Radio Access Bearer (RAB) in UTRAN or Packet Flow Context (PFC) in GERAN. However, there is implicit information of the end-user service if a bearer service is solely used for a specific service. For example, this is the case for circuit-switched voice or video telephony in UTRAN. For packet-switched services, there may be multiple end-user services using the same bearer service. Thus, there is no possibility to monitor the performance of a particular end-user service by observing the performance of the bearer service.

Technical Specification 3GPP TS 23.107, Quality of Service (QoS) Concept and Architecture, defines the framework for QoS within UMTS. Four Traffic Classes are defined with corresponding QoS attributes for the UMTS bearer and the RAB. The RAB QoS attributes provide input to the Radio Resource Management (RRM) functions in the RAN. Currently, no information regarding the particular service provided over the bearer is available in the QoS attributes. The same applies for the QoS attributes in GERAN provided by the Aggregate BSS Quality Profile (ABQP) defined in 3GPP TS 48.018. This is intentional to provide a functional split and thereby reduce dependencies and complexity.

In the standardization of the Long Term Evolution (LTE) within 3GPP, a new QoS service concept is discussed. This concept will also require the service to be known by the RAN in order to observe performance per service. The number of QoS attributes will be reduced, which increases the likelihood that any single bearer service, possible to distinguish in the RAN, will be used by multiple end-user services.

What is needed in the art is a system and method for monitoring the performance of a RAN that overcomes the shortcomings of the prior art. Such a system and method should monitor individual services and optionally control QoS in the RAN. The present invention provides such a system and method.

### BRIEF SUMMARY OF THE INVENTION

The present invention provides a means for monitoring performance of a service in a RAN (e.g., UTRAN, GERAN, LTE, or IEEE WiMAX) by identifying the particular service as part of the bearer attributes in the RAN. The invention enables the RAN to provide measured performance information that is much closer to the user-perceived quality. This is not explicitly possible today in UTRAN or GERAN for packet services, where several end-user services utilize the same bearer service in the RAN.

In one aspect, the present invention is directed to a method of monitoring performance of an identified service in a radio access network in which multiple end-user services utilize the same bearer service in a radio access network. The method includes sending a service identifier from a core network node to the radio access network. The service identifier identifies the end-user service or group of services to be monitored. The method also includes configuring measurements in the radio access network to report performance of the identified service. The service identifier may be sent as a tag in a radio bearer request message or a radio bearer modification message, and the radio access network may be configured to apply different parameter settings for network counters depending on the service identifier tag received in the radio bearer request message.

In another aspect, the present invention is directed to a system for monitoring performance of an identified service in a radio access network in which multiple services utilize the same bearer service in the radio access network. The system includes a core network node for sending a service identifier to the radio access network, and at least one service event counter in the radio access network for measuring performance parameters for the identified service. The core network node preferably sends the service identifier upon bearer service establishment or modification, although in cases where a default bearer service is set up before there is a service to support, the service identifier may be sent later when the service becomes known. The core network node may include an operator-configurable mapping table for mapping services to service identifiers.

In another aspect, the present invention is directed to a node in a telecommunications core network. The node includes communication means for receiving from an originating party, a request to set up or modify a requested service; an operator-configurable mapping table for mapping the requested service to a service identifier; and an interface with a radio access network for sending to the radio access network, a request to set up the requested service and a request for a bearer service, wherein the request for a bearer service includes the service identifier.

### BRIEF DESCRIPTION OF THE SEVERAL VIEWS OF THE DRAWING

In the following, the essential features of the invention will be described in detail by showing preferred embodiments, with reference to the attached figures in which:

FIG. 1 is a simplified signaling diagram illustrating the flow of signaling messages in a first embodiment of the present invention in a UTRAN;

FIG. 2 is a table of information elements (IEs) in a RAB Assignment Request message modified in accordance with the teachings of the present invention;

FIG. 3 is a signaling diagram illustrating the flow of signaling messages when the present invention is implemented for a mobile terminated call; and

FIG. 4 is a simplified block diagram of an embodiment of the system of the present invention.

### DETAILED DESCRIPTION OF THE INVENTION

User-perceived quality is typically dependent on the end-user service being provided. For example, data losses in a progressive download video stream give very different results if they come in bursts than if they are evenly distributed. Counters and event records in the RAN are typically “generic” to allow fast service rollout. The generic counters and events typically need service-adapted post-processing to provide a correct operator view of the user perception.

Ongoing standardization activities within 3GPP for the IP Multimedia Subsystem (IMS) aim at specifying Communication Service Identifiers (CSIs) in order for IMS to act properly depending on a particular service. These standardization activities are detailed in 3GPP TS23.228, IP Multimedia Subsystem (IMS) and 3GPP TR 23.816, Identification of Communication Services in IMS. The CSIs are currently not known by the RAN, but in the present invention, may be provided as part of the bearer attributes in order for the RAN to act based on the specific end-user service. The attribute may be based on the entire CSI or applicable parts of the CSI. This enables the RAN to both tailor the RRM for a particular end-user service and also provide the capability to observe a particular end-user service even if transported over a bearer also used by other end-user services.

In order to generalize the concept to also cover non-IMS services, the present invention provides mapping between the service descriptions in the Service Layer or in IMS to a service description in the RAN. This mapping may be performed in the Core Network (CN). The Service Description in the Service Layer, as known by the CN, may be based on the IP address, APN, or any other available information. The mapping preferably provides a one-to-one mapping of end-user services as well as a mechanism to group multiple end-user services into a Service Identifier in the RAN. Note that this does not violate the functional split, since it only provides one or more “tags” per RAB/PFC, which allows service-dependent monitoring and post-processing of the “generic” statistical data. Hence the RAN is not required to do any service-specific actions.

For GERAN and UTRAN, a new attribute (Service Identifier) describing the service applied is added to the bearer attributes defined in 3GPP 25.413, UTRAN Iu Interface RANAP Signaling, and in 48.018, BSS GPRS Protocol (BSSGP). The Service Identifier attribute has a value of one or more numbers, each representing one end-user service or one group of end-user services, which need similar post-processing in order to calculate the user-perceived quality. The Service Identifier attribute is applied to all Traffic Classes. Table 1 below is a modified table from 3GPP TS 23.107, Quality of Service (QoS) Concept and Architecture. The table has been modified to show the additions relating to the Service Identifier attribute. The additions indicate that the Service Identifier attribute shall be available, for example, when establishing the PDP Context and establishing the RAB in the UTRAN.

TABLE 1

| | | | | Back- |
|---|---|---|---|---|
| | Conversational | Streaming | Interactive | ground |
| Traffic class | class | class | class | class |
| Maximum bitrate | X | X | X | X |
| Delivery order | X | X | X | X |
| Maximum SDU size | X | X | X | X |
| SDU format | X | X | | |
| information | | | | |
| SDU error ratio | X | X | X | X |
| Residual bit error ratio | X | X | X | X |
| Delivery of erroneous | X | X | X | X |
| SDUs | | | | |
| Transfer delay | X | X | | |
| Guaranteed bit rate | X | X | | |
| Traffic handling | | | X | |
| priority | | | | |
| Allocation/Retention | X | X | X | X |
| priority | | | | |
| Source statistics | X | X | | |
| descriptor | | | | |
| Signalling Indication | | | X | |
| Service Identifier | X | X | X | X |

For GPRS, the same mapping applies for the Aggregate BSS QoS Profile (ABQP) in 3GPP TS 48.018, BSS GPRS Protocol (BSSGP).

For LTE, the QoS parameters are largely undefined, but a bearer concept for LTE is being defined, probably including QoS parameters for Priority Class, Traffic Handling Priority, Allocation/Retention Priority, and Guaranteed Bit Rate. The Service Identifier attribute may be appended at the bearer establishment.

For WiMAX, it is noted that 802.16 has a “Service Flow” concept, which corresponds to both the PDP Context and the radio bearer (RAB/PFC). However, if WiMAX standardization splits the implementation between different entities, then the “Service Identifier” tag is just as useful as in GERAN/UTRAN/LTE.

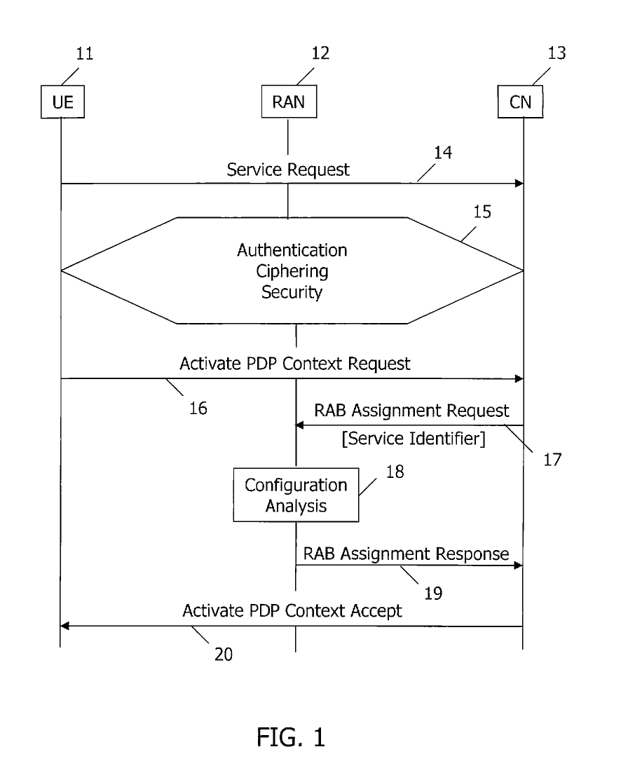

FIG. 1 is a signaling diagram illustrating the flow of signaling messages in a first embodiment of the present invention. In this embodiment, the invention utilizes modified signaling procedures in a UTRAN or GSM/GPRS radio access network using the Iu interface. The signaling is performed by a Mobile Station/User Equipment (UE) 11, a RAN 12, and a core network (CN) 13. At step 14, the UE sends a Service Request message to the CN. At step 15, authentication, ciphering, and security procedures are performed between the UE and the network entities. At step 16, the UE sends an Activate PDP Context Request message to the CN. In response, the CN sends a modified RAB Assignment Request message 17 to the RAN. This message is sent by the CN to request the establishment, modification, or release of one or more RABs for the same UE. The message source node may be a Serving GPRS Support Node (SGSN), and the target node may be, for example, a Radio Network Controller (RNC) for UMTS or a Base Station Controller (BSC) for GSM/GPRS.

The modified RAB Assignment Request message 13 includes the new Service Identifier and QoS information, which is used to set up the bearer service. The information is preferably sent at radio bearer establishment (for example, setup of a RAB/PFC for a VoIP call) or radio bearer modification (for example, modification of a radio bearer used for VoIP to carry both VoIP and Video). If there are “pre-defined” or “default” bearers which are established before there is any service to be supported (such a concept exists in WiMAX and is proposed for UTRAN and LTE), then the Service Identifier(s) may be sent when the service becomes known. However, the invention is not limited to this implementation, and the information may also be provided later. Sending the information later is not preferred because recorded QoS statistics will be unspecified until the Service Indicator is known.

At step 18, the RAN 12 performs a configuration analysis, and then sends a RAB Assignment Response message 19 to the CN 13. At step 20, the CN sends an Activate PDP Context Accept message to the UE 11.

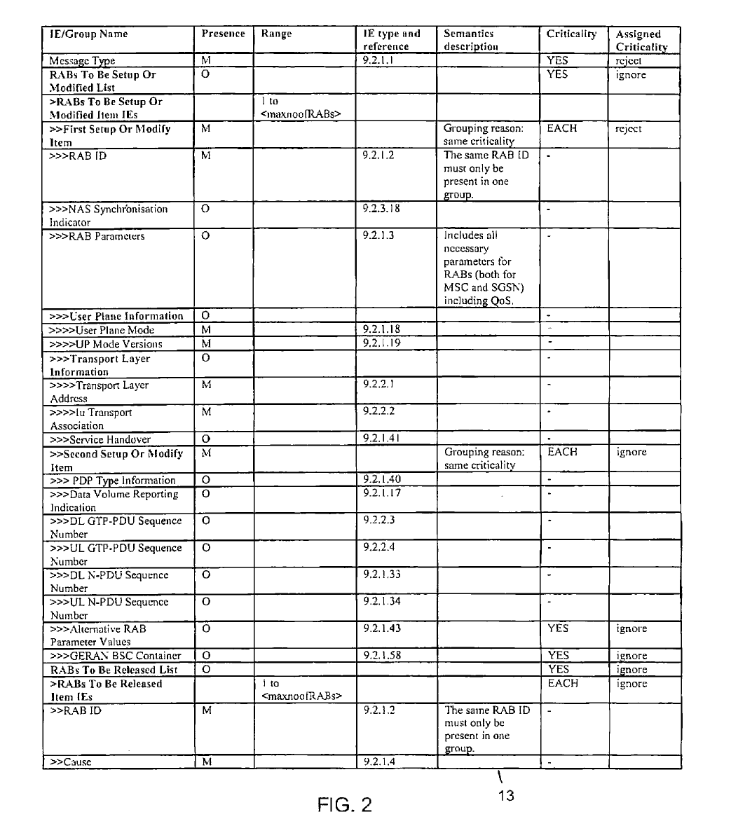

FIG. 2 is a table of information elements (IEs) in the modified RAB Assignment Request message 13. The new Service Identifier may be added, for example, to the “RAB Parameters” in the “RABs To Be Setup Or Modified Item lEs” group. One or several Service Identifiers may be indicated for each RAB (typically one per RAB).

In other embodiments of the present invention, different messages may be utilized to convey the new Service Identifier from the CN 11 to the RNS 14. For example, for GSM/GPRS using the Gb interface, the Service Identifier may be included in the CREATE-BSS-PFC message (see 3GPP 48.018 section 10.4.17). Following a DOWNLOAD-BSS-PFC-PDU, if there is not an ongoing Delete Packet Flow Context (PFC) procedure for that corresponding Packet Flow Identifier (PFI), the SGSN sends a CREATE-BSS-PFC PDU to the BSS with a requested Aggregate BSS QoS Profile and Start Timer T7. The BSS stops Timer T6, and responds with a CREATE-BSS-PFC-ACK PDU containing the negotiated Aggregate BSS QoS Profile. The new Service Identifier(s) may be added anywhere in the CREATE-BSS-PFC message, with one or several Service Identifiers per PFC (typically one per PFC).

As an example of usage of the invention, consider that today one and the same bearer is used for end-user services such as PushToTalk (PTT), VoIP, Gaming, web browsing, and email (at least for different subscribers or different occasions). It is unusual that one subscriber simultaneously uses different end-user services. The perceived effects of channel bandwidth adaptation delays, interruptions, and the like are quite different for these end-user services. An interruption of 0.5 seconds is annoying for VoIP, but not for email, where the ‘acceptance limit’ may be around 5 seconds. Statistics are normally generated on the cell level (to be able to identify “problem cells”) and per bearer (because different counters and event recordings are relevant for different kinds of bearers).

One solution for determining per-service statistics is to provide “all kinds of measurements” and then the operator can guess the proportion of dissatisfied PTT/Gaming/web/email users. This solution implies there is an abundance of counters and recordings, each applicable only to some end-user services. It also implies difficulties in post-processing the data to estimate/guess the proportion of dissatisfied users. Instead, there may be a set of “generic” counters and events, which are parameterized and sorted per Service Identifier. The advantages of this solution include less processing and memory to generate and store the statistics and a much clearer presentation of Key Performance Indicators per service.

In the past, it has been desirable for RANs to be service-unaware, in order to reduce logical dependencies (=complexity). The present invention supports such logical independence if the “Service Identifier(s)” is/are just a tag or number, and the RAN is configured to apply different parameter settings for counters/events, depending on the tag. In such a case, the RAN has a ‘generic’ handling based on a tag. The actual mapping of service to Service Identifier tag is typically also an operator configuration. Operators can tag the end-user services they are most interested in analyzing. The Service Identifier may be, for example, an 8-bit field so that up to 256 end-user services can be identified.

The existing way to handle QoS of different services in the fixed network is to have an operator-controlled configuration of the bearers. This method is being copied to cellular networks. For several reasons, it is desired to minimize the number of bearers. The present invention improves the feedback of perceived service quality. In this way, operators can efficiently (a) design end-user services, (b) design or re-use bearers for these services (which implies a delicate balance between quality and consumed network capacity, i.e. ‘cost’) and (c) reassess the quality, which may lead to a new iteration at step (a).

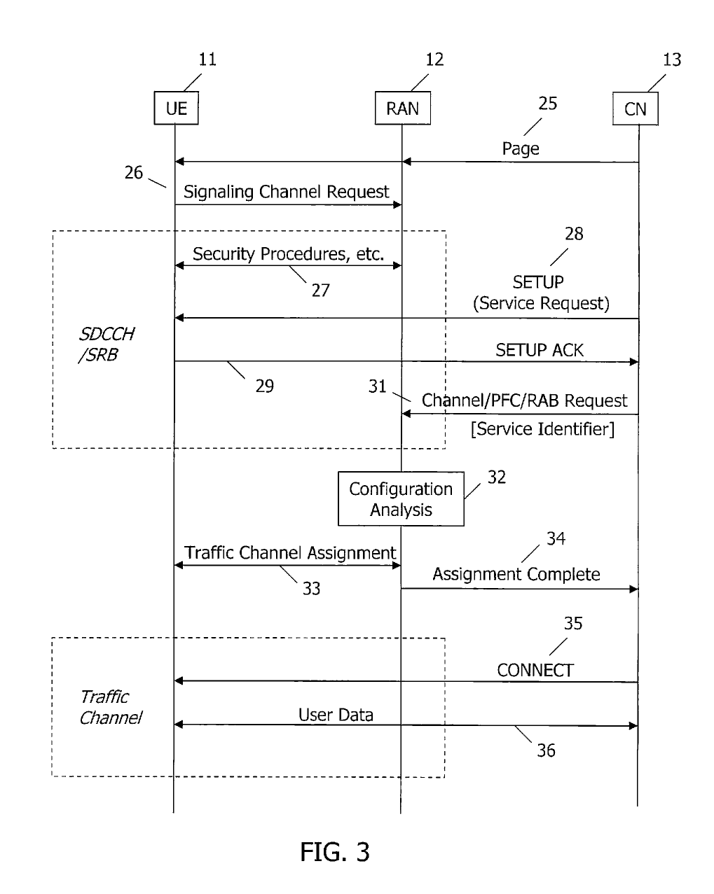

FIG. 3 is a signaling diagram illustrating the flow of signaling messages when the present invention is implemented for a mobile-terminated call. The CN 13 sends a page message 25 via the RAN 12 to the UE 11 operating in Idle Mode. The UE responds by sending a Signaling Channel Request message 26 to the RAN and entering the Connected Mode. Authentication and other security procedures are performed at step 27. The CN then sends a Setup message 28 to the UE with a service request. The “real” service is only known here. The UE responds by sending a Setup Acknowledgment message 29 back to the CN.

The CN 13 then sends a Channel/PFC/RAB Request message 31 to the RAN 12. The Channel/PFC/RAB Request message is modified to include the new Service Identifier attribute. Almost all performance measurements are collected by the RAN. The Service Identifier prompts the RAN to configure measurements to fit the service characteristics, thereby simplifying quality monitoring and optionally, quality control. At step 32, the RAN performs a configuration analysis, and at step 33, the UE and the RAN exchange messages for traffic channel assignment. At step 34, the RAN sends an Assignment Complete message to the CN, and at step 35, a connection is established between the CN and the UE on an assigned traffic channel. User data 36 is then exchanged between the CN and the UE.

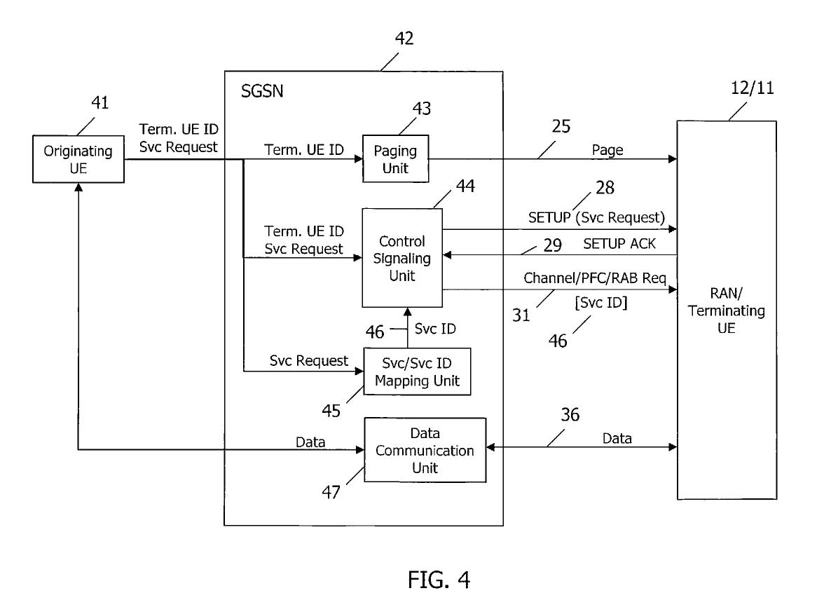

FIG. 4 is a simplified block diagram of an embodiment of the system of the present invention. With reference to FIGS. 3 and 4, the operation of the system will be explained. An originating UE 41 sends a request message through the CN 13 to an SGSN 42 serving the terminating UE 11. The request includes an identifier for the terminating UE and a service request. A paging unit 43 in the SGSN uses the terminating UE identifier to send a page message through the RAN 12 to the terminating UE 11. The RAN and terminating UE then set up a signaling channel and perform security procedures. A control signaling unit 44 uses the terminating UE identifier and the service request to send the Setup message 28 with the service request to the RAN/terminating UE. The terminating UE sends the Setup Acknowledgment 29 back to the SGSN.

The SGSN includes a Service-to-Service Identifier mapping unit 45. The service request received from the originating UE is input to the mapping unit, and the Service Identifier 46 is output to the control signaling unit 44. The control signaling unit sends the Channel/PFC/RAB request message 31 to the RAN 12 and includes the Service Identifier. The RAN and the UE then set up a traffic channel and establish a data connection for exchanging data 36 between the originating UE 41 and the terminating UE 11. As noted above, the Service Identifier 46 prompts the RAN to configure measurements to fit the service characteristics, thereby simplifying quality monitoring and optionally, quality control.

It should be noted that the inventive Service-to-Service Identifier mapping unit 45 is not limited to implementation within an SGSN. It may also be implemented in other nodes within the core network or optionally within the RAN.

Although preferred embodiments of the present invention have been illustrated in the accompanying drawings and described in the foregoing Detailed Description, it is understood that the invention is not limited to the embodiments disclosed, but is capable of numerous rearrangements, modifications, and substitutions without departing from the scope of the invention. The specification contemplates any all modifications that fall within the scope of the invention defined by the following claims.

What is claimed is:

1. A method of monitoring performance of an identified end-user service in a radio access network in which multiple end-user services utilize the same bearer service, said method comprising:
sending a service identifier from a core network node to the radio access network, said service identifier identifying the end-user service to be monitored; and
configuring measurements in the radio access network to report performance parameters for the identified end-user service.

2. The method according to claim 1, wherein the sending step includes sending the service identifier upon radio bearer establishment.

3. The method according to claim 1, wherein the sending step includes sending the service identifier upon radio bearer modification.

4. The method according to claim 1, further comprising, before the sending step, the step of establishing a default radio bearer before there is an end-user service to be supported, wherein the sending step includes sending the service identifier after radio bearer establishment when the identified end-user service becomes known.

5. The method according to claim 1, wherein the core network is a Universal Mobile Telecommunication System (UMTS) network, and the sending step includes sending the service identifier in a RAB Assignment Request message or a RAB Modification Request message from a Serving GPRS Service Node (SGSN) in the UMTS core network to a Radio Network Controller (RNC) in a UMTS Terrestrial Radio Access Network (UTRAN).

6. The method according to claim 1, wherein the core network is a GSM/GPRS network utilizing an Iu interface with the radio access network, and the sending step includes sending the service identifier in a RAB Assignment Request message or a RAB Modification Request message from a Serving GPRS Service Node (SGSN) in the GSM/GPRS core network to a Base Station Controller (BSC) in the radio access network.

7. The method according to claim 1, wherein the core network is a GSM/GPRS network utilizing a Gb interface with the radio access network, and the sending step includes sending the service identifier in a Create-BSS-PFC Request message from a Serving GPRS Service Node (SGSN) in the GSM/GPRS core network to a Base Station Controller (BSC) in the radio access network.

8. The method according to claim 1, wherein the sending step includes sending the service identifier as a tag in a radio bearer request message.

9. The method according to claim 8, wherein the configuring step includes configuring the radio access network to apply different parameter settings for network counters depending on the service identifier tag received in the radio bearer request message.

10. The method according to claim 1, further comprising providing an operator-configurable mapping table for mapping end-user services to service identifiers.

11. A system for monitoring performance of an identified end-user service in a radio access network in which multiple end-user services utilize the same bearer service, said system comprising:
a core network node for sending a service identifier to the radio access network, said service identifier identifying the end-user service to be monitored; and
at least one service event counter in the radio access network for measuring performance parameters for the identified end-user service.

12. The system according to claim 11, wherein the core network node includes means for sending the service identifier upon radio bearer establishment.

13. The system according to claim 11, wherein the core network node includes means for sending the service identifier upon radio bearer modification.

14. The system according to claim 11, wherein the radio access network establishes a default radio bearer before there is an end-user service to be supported and the core network node includes means for sending the service identifier to the radio access network after radio bearer establishment when the identified end-user service becomes known.

15. The system according to claim 11, wherein the core network is a Universal Mobile Telecommunication System (UMTS) network and the core network node is a Serving GPRS Service Node (SGSN), wherein the SGSN includes means for sending the service identifier in a RAB Assignment Request message or a RAB Modification Request message to a Radio Network Controller (RNC) in a UMTS Terrestrial Radio Access Network (UTRAN).

16. The system according to claim 11, wherein the core network is a GSM/GPRS network utilizing an Iu interface with the radio access network, and the core network node is a Serving GPRS Service Node (SGSN), wherein the SGSN includes means for sending the service identifier in a RAB Assignment Request message or a RAB Modification Request message to a Base Station Controller (BSC) in the radio access network.

17. The system according to claim 11, wherein the core network is a GSM/GPRS network utilizing a Gb interface with the radio access network, and the core network node is a Serving GPRS Service Node (SGSN), wherein the SGSN includes means for sending the service identifier in a Create-BSS-PFC Request message to a Base Station Controller (BSC) in the radio access network.

18. The system according to claim 11, wherein the core network node includes means for sending the service identifier as a tag in a radio bearer request message.

19. The system according to claim 18, wherein the at least one service event counter in the radio access network is configurable to measure different performance parameters depending on the service identifier tag received in the radio bearer request message.

20. The system according to claim 11, wherein the core network node includes an operator-configurable mapping table for mapping services to service identifiers.

21. A node in a telecommunications core network, comprising:
communication means for receiving from an originating party, a request to set up or modify a requested end-user service;
an operator-configurable mapping table for mapping the requested end-user service to a service identifier; and
an interface with a radio access network, said interface for sending to the radio access network, a request to set up the requested end-user service and a request for a radio bearer, said request for a radio bearer including the service identifier.

22. The core network node according to claim 21, wherein the node sends the service identifier to the radio access network upon radio bearer establishment.

23. The core network node according to claim 21, wherein the core network is a Universal Mobile Telecommunication System (UMTS) network and the core network node is a Serving GPRS Service Node (SGSN), wherein the SGSN includes means for sending the service identifier in a RAB Assignment Request message or a RAB Modification Request message to a Radio Network Controller (RNC) in a UMTS Terrestrial Radio Access Network (UTRAN).

24. The core network node according to claim 21, wherein the core network is a GSM/GPRS network utilizing an Iu interface with the radio access network, and the core network node is a Serving GPRS Service Node (SGSN), wherein the SGSN includes means for sending the service identifier in a RAB Assignment Request message or a RAB Modification Request message to a Base Station Controller (BSC) in the radio access network.

25. The core network node according to claim 21, wherein the core network is a GSM/GPRS network utilizing a Gb interface with the radio access network, and the core network node is a Serving GPRS Service Node (SGSN), wherein the SGSN includes means for sending the service identifier in a Create-BSS-PFC Request message to a Base Station Controller (BSC) in the radio access network.

26. The core network node according to claim 21, wherein the interface includes means for sending the service identifier to the radio access network as a tag in a radio bearer request message.
